(19) United States
(12) Patent Application Publication
(10) Pub. No.: US 2025/0118025 A1
(43) Pub. Date: Apr. 10, 2025

(54) FLEXIBLE 3D LANDMARK DETECTION

(71) Applicant: DISNEY ENTERPRISES, INC., Burbank, CA (US)

(72) Inventors: Prashanth CHANDRAN, Zürich (CH); Gaspard ZOSS, Zürich (CH); Derek Edward BRADLEY, Zürich (CH)

(21) Appl. No.: 18/906,555

(22) Filed: Oct. 4, 2024

Related U.S. Application Data
(60) Provisional application No. 63/588,640, filed on Oct. 6, 2023.

(51) Int. Cl. G06T 17/20; G06T 7/70; G06V 40/16

(52) U.S. Cl. CPC G06T 17/20; G06T 7/70; G06V 40/171; G06T 2207/20081; G06V 2201/07

(57) ABSTRACT

One embodiment of the present invention sets forth a technique for performing landmark detection. The technique includes determining a first set of parameters associated with a depiction of a first face in a first image. The technique also includes generating, via execution of a first machine learning model, a first set of three-dimensional (3D) landmarks on the first face based on the first set of parameters, and projecting, based on the first set of parameters, the first set of 3D landmarks onto the first image to generate a first set of two-dimensional (2D) landmarks. The technique further includes training the first machine learning model based on one or more losses associated with the first set of 2D landmarks to generate a first trained machine learning model.

### CROSS-REFERENCE TO RELATED APPLICATIONS

This application claims the benefit of the U.S. provisional application titled “Limitless 3D Landmark Detection,” filed on Oct. 6, 2023, and having Ser. No. 63/588,640. This related application is also hereby incorporated by reference in its entirety.

### BACKGROUND

### Field of the Various Embodiments

Embodiments of the present disclosure relate generally to machine learning and computer vision and, more specifically, to techniques for flexible 3D landmark detection.

### DESCRIPTION OF THE RELATED ART

Facial landmark detection refers to the detection of a set of specific key points, or landmarks, on a face that is depicted within an image and/or video. For example, a standard landmark detection technique may predict a set of 68 sparse landmarks that are spread across the face in a specific, predefined layout. The detected landmarks can then be used in various computer vision and computer graphics applications, such as (but not limited to) three-dimensional (3D) facial reconstruction, facial tracking, face swapping, segmentation, and/or facial re-enactment.

Deep learning approaches for predicting facial landmarks can generally be categorized into main types: direct prediction methods and heatmap prediction methods. In direct prediction methods, the x and y coordinates of the various landmarks are directly predicted by processing facial images. In heatmap prediction methods, the distribution of each landmark is first predicted, and the location of each landmark is subsequently extracted by maximizing that distribution function.

However, existing landmark detection techniques are associated with a number of drawbacks. First, most landmark detectors perform a face normalization pre-processing step that crops and resizes a face in an image. This normalization is commonly performed by a separate neural network with no knowledge of the downstream landmark detection task. Consequently, normalized images outputted by this face normalization pre-processing step may exhibit temporal instability and/or other attributes that negatively impact the detection of facial landmarks in the images.

Second, facial landmarks are typically predicted during a preprocessing step for a downstream task, such as determining the pose and/or 3D shape of the corresponding head. This downstream task involves additional processing related to the predicted facial landmarks, which consumes time and computational resources beyond those used to predict the facial landmarks.

Third, many deep-learning-based landmark detectors are trained on multiple datasets from different sources. Each dataset includes a large number of face images and corresponding 2D landmark annotations. While these datasets aim to portray the same predefined set of landmarks on each face to facilitate cross-dataset training, inconsistencies in human annotation can result in minor discrepancies in landmark semantics from one dataset to another. For example, a landmark for the tip of a nose may have an annotation in one dataset that is consistently higher than in another, thereby corresponding to a different semantic location on the face. In turn, these datasets may present contradictory information that negatively impacts the training of the landmark detector and/or the performance of the resulting trained landmark detector.

As the foregoing illustrates, what is needed in the art are more effective techniques for performing landmark detection.

### SUMMARY

One embodiment of the present invention sets forth a technique for performing landmark detection. The technique includes determining a first set of parameters associated with a depiction of a first face in a first image. The technique also includes generating, via execution of a first machine learning model, a first set of three-dimensional (3D) landmarks on the first face based on the first set of parameters, and projecting, based on the first set of parameters, the first set of 3D landmarks onto the first image to generate a first set of two-dimensional (2D) landmarks. The technique further includes training the first machine learning model based on one or more losses associated with the first set of 2D landmarks to generate a first trained machine learning model.

One technical advantage of the disclosed techniques is the ability to predict the landmarks as 3D positions in a canonical space. These 3D positions may then be used to perform 3D facial reconstruction, texture completion, visibility estimation, and/or other tasks, thereby reducing latency and resource overhead over prior techniques that generate 2D landmarks and perform additional processing related to the 2D landmarks during downstream tasks. These predicted attributes may additionally result in more stable 2D landmarks than conventional approaches that perform landmark detection only in 2D space. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the training engine and execution engine of FIG. 1, according to various embodiments of the present disclosure.

FIG. 3 illustrates the operation of the machine learning models of FIG. 2 in generating landmarks for a face depicted in an image, according to various embodiments of the present disclosure.

FIG. 4 illustrates different sets of data associated with the machine learning models of FIG. 2, according to various embodiments.

FIG. 5 is a flow diagram of method steps for performing joint image normalization and landmark detection, according to various embodiments.

FIG. 6 is a flow diagram of method steps for performing flexible three-dimensional (3D) landmark detection, according to various embodiments.

FIG. 7 is a flow diagram of method steps for performing query deformation for landmark annotation correction, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

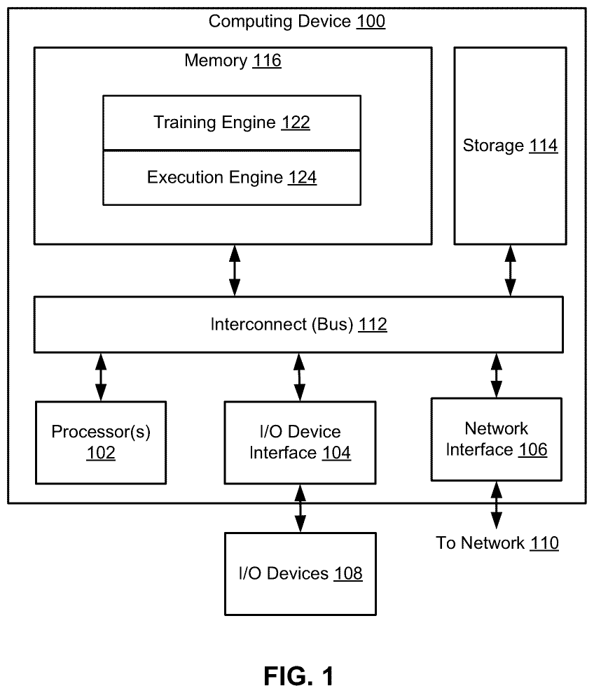

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in memory 116.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and/or execution engine 124 could execute on various sets of hardware, types of devices, or environments to adapt training engine 122 and/or execution engine 124 to different use cases or applications. In a third example, training engine 122 and execution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In one or more embodiments, training engine 122 and execution engine 124 use a set of machine learning models to perform and/or improve various tasks related to facial landmark detection. These tasks include learning to perform a face normalization preprocessing step that crops and resizes a face in an image in a manner that is optimized for a downstream facial landmark detection task. These tasks may also, or instead, include predicting a pose, head shape, camera parameters, and/or other attributes associated with the landmarks in a canonical three-dimensional (3D) space and using the predicted attributes to predict 3D landmarks in the same canonical space while using two-dimensional (2D) landmarks as supervision. These tasks may also, or instead, include displacing query points associated with different annotation styles in training data for the facial landmark detection task to correct for semantic inconsistencies in query point annotations across different datasets. Training engine 122 and execution engine 124 are described in further detail below.

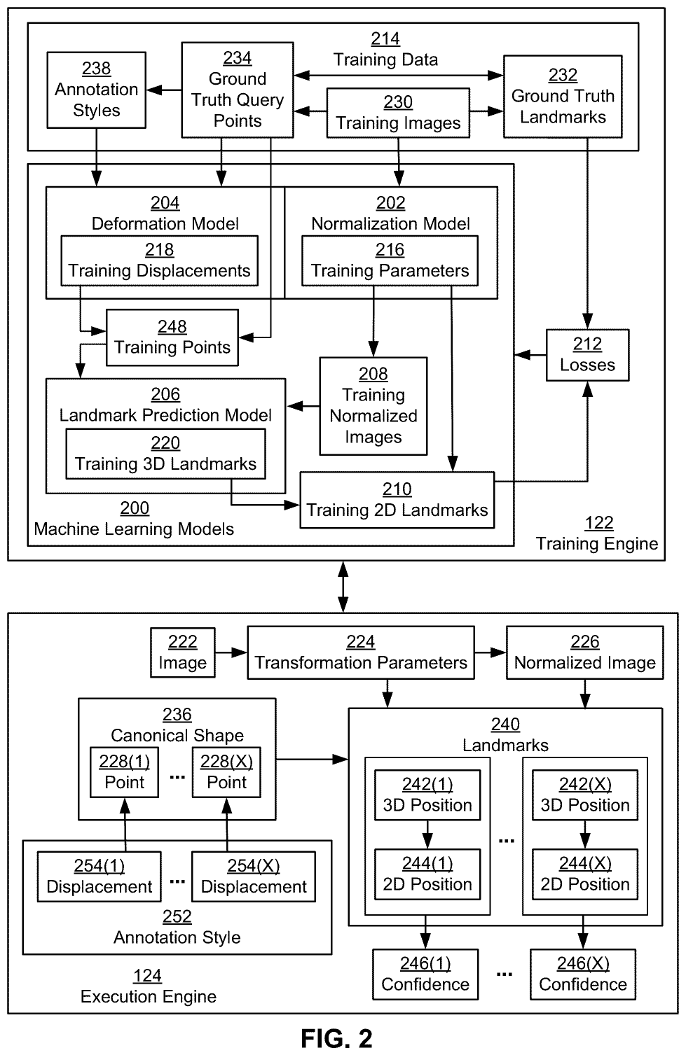

FIG. 2 is a more detailed illustration of training engine 122 and execution engine 124 of FIG. 1, according to various embodiments. As mentioned above, training engine 122 and execution engine 124 operate to train and execute a set of machine learning models 200 on a facial landmark detection task, in which a set of landmarks 240 is detected as a set of key points on a face depicted within an image 222.

In some embodiments, a landmark includes a distinguishing characteristic or point of interest in a given image (e.g., image 222). Examples of facial landmarks 240 include (but are not limited to) the inner or outer corners of the eyes, the inner or outer corners of the mouth, the inner or outer corners of the eyebrows, the tip of the nose, the tips of the ears, the location of the nostrils, the tip of the chin, a facial feature (e.g., a mole, birthmark, etc.), and/or the corners or tips of other facial marks or points. Any number of landmarks 240 can be determined for individual facial regions such as (but not limited to) the eyebrows, right and left centers of the eyes, nose, mouth, ears, and/or chin.

As shown in FIG. 2, machine learning models 200 include a normalization model 202, a deformation model 204, and a landmark prediction model 206. Landmark prediction model 206 includes various neural networks and/or other machine learning components that are used to predict landmarks 240 for a face in image 222. More specifically, landmark prediction model 206 may generate landmarks 240 as 3D positions 242(1)-242(X) (each of which is referred to individually herein as 3D position 242) in a canonical space associated with a canonical shape 236 and/or 2D positions 244(1)-244(X) (each of which is referred to individually herein as 2D position 244) in a 2D space associated with image 222. Landmark prediction model 206 may also, or instead, generate confidences 246(1)-246(X) (each of which is referred to individually herein as confidence 246) associated with individual 3D positions 242 and/or 2D positions 244, where each confidence 246 includes a include numeric value representing a measure of confidence and/or certainty in the predicted position for a corresponding landmark.

In one or more embodiments, landmarks 240 are generated for an arbitrary set of points 228(1)-228(X) (each of which is referred to individually herein as point 228) that are defined on canonical shape 236. For example, canonical shape 236 may include a fixed template face surface that is parameterized into a 2D UV space. Each point 228 may be defined as a 2D UV coordinate that corresponds to a specific position on the template face surface and/or as a 3D coordinate in the canonical space around the template face surface.

Normalization model 202 generates transformation parameters 224 that convert image 222 into a normalized image 226. For example, transformation parameters 224 may be used to crop and/or resize a face in image 222 so that the resulting normalized image 226 excludes extraneous information that is not relevant to the detection of landmarks 240 on the face. Normalized image 226 and points 228 on canonical shape 236 are inputted into landmark prediction model 206. In turn, landmark prediction model 206 outputs 2D positions 244 that correspond to the inputted points 226 and include locations in normalized image 226.

Deformation model 204 generates displacements 254(1)-254(X) (each of which is referred to individually herein as displacement 254) of points 228 that reflect a given annotation style 252 associated with training data 214 for machine learning models 200. For example, each annotation style 252 may correspond to a different semantic interpretation of landmarks 240 on a given face. Displacements 254 may thus be used to shift points 228 that are defined with respect to canonical shape 236 in a way that aligns with the semantic interpretation associated with a corresponding annotation style 252.

Training engine 122 trains normalization model 202, deformation model 204, and/or landmark prediction model 206 using training data 214 that includes training images 230, ground truth landmarks 232 associated with training images 230, ground truth query points 234 that are defined with respect to canonical shape 236, and annotation styles 238 associated with ground truth query points 234. Training images 230 include images of faces that are captured under various conditions. For example, training images 230 may include real and/or synthetic images of a variety of faces in different poses and/or facial expressions, at different scales, in various environments (e.g., indoors, outdoors, against different backgrounds, etc.), under various conditions (e.g., studio, “in the wild,” low light, natural light, artificial light, etc.), and/or using various cameras.

Ground truth landmarks 232 include 2D positions in training images 230 that correspond to ground truth query points 234 in the 3D canonical space associated with canonical shape 236. For example, ground truth landmarks 232 may include 2D pixel coordinates in training images 230, 2D coordinates in a 2D space that is defined with respect to some or all training images 230, and/or another representation. Ground truth query points 234 may include 2D UV coordinates on the surface of the template face corresponding to canonical shape 236, 3D coordinates in the canonical space, and/or another representation. Each ground truth landmark may be associated with a corresponding training image and a corresponding ground truth query point within training data 214.

As discussed above, annotation styles 238 represent different semantic interpretations of manually annotated ground truth query points 234. For example, two different datasets of training images 230 and corresponding ground truth landmarks 232 may be associated with different annotation styles 238, such that the annotation for a ground truth query point corresponding to the tip of a nose is consistently higher in one dataset than in another. In this example, a unique name and/or identifier for each dataset may be used as a corresponding annotation style for ground truth query points 234 in the dataset. In another example, annotation styles 238 may capture per-person differences in annotating ground truth query points 234 and/or other sources of semantic differences in ground truth query points 234 within training data 214.

As shown in FIG. 2, training engine 122 inputs ground truth query points 234 and the corresponding annotation styles 238 into deformation model 204. In response to the inputted data, deformation model 204 generates training displacements 218 associated with ground truth query points 234.

Training engine 122 also inputs training images 230 into normalization model 202. For each inputted training image, normalization model 202 generates a set of training parameters 216 that specify a transformation to be applied to the training image. Training engine 122 uses training parameters 216 to apply the transformations to training images 230 and generate corresponding training normalized images 208. Training engine 122 also applies training displacements 218 to ground truth query points 234 to produce a set of training points 248.

Training engine 122 inputs training points 248 and training normalized images 208 into landmark prediction model 206. Based on this input, landmark prediction model 206 generates training 3D landmarks 220 that correspond to positions of training points 248 in the canonical 3D space associated with canonical shape 236.

Training engine 122 uses training parameters 216 for each training image to convert training 3D landmarks 220 for that training image into a set of training 2D landmarks 210 in a 2D space associated with the training image. Training engine 122 computes one or more losses 212 between training 2D landmarks 210 and the corresponding ground truth landmarks 232. Training engine 122 additionally uses a training technique (e.g., gradient descent and backpropagation) to iteratively update parameters of normalization model 202, deformation model 204, and/or landmark prediction model 206 in a way that reduces losses 212.

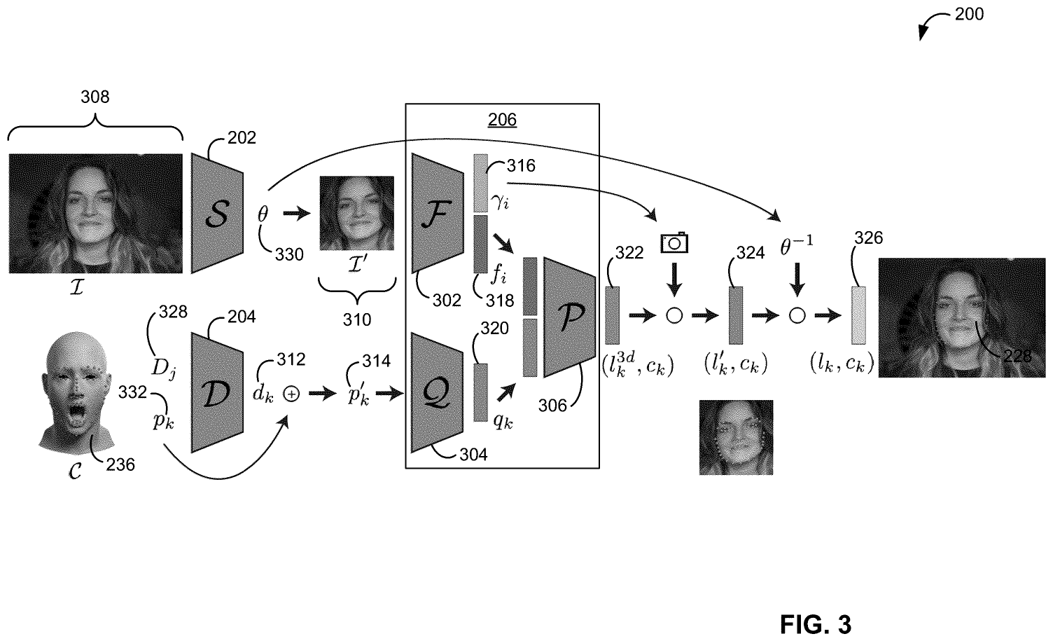

FIG. 3 illustrates the operation of machine learning models 200 of FIG. 2 in generating landmarks 322, 324, and 326 for a face depicted in an image 308, according to various embodiments of the present disclosure. As shown in FIG. 3, image 308 (which can be included in training images 230 and/or correspond to a new image 222 that is not included in training data 214 for machine learning models 200) is denoted by J and inputted into normalization model 202. Normalization model 202 generates, from the inputted image 222, parameters 330 θ of a 2D transformation. When image 308 is used to train machine learning models 200, parameters 330 may correspond to training parameters 216. When image 308 is not used to train machine learning models 200, parameters 330 may correspond to transformation parameters 224.

Parameters 330 are used to apply the 2D transformation to image 222 and generate a corresponding normalized image 310 that is denoted by [symbol] ′. When image 308 is used to train machine learning models 200, normalized image 310 may be included in training normalized images 208. When image 308 is not used to train machine learning models 200, normalized image 310 may correspond to normalized image 226.

In one or more embodiments, normalization model 202 includes a convolutional neural network (CNN) and/or another type of machine learning model. For example, normalization model 202 may include a spatial transformer neural network that outputs parameters 330 θ of a spatial transformation based on input that includes image 308. These parameters 330 may be used to construct a 2×3 transformation matrix that is used to generate a sampling grid that specifies a set of spatial locations to be sampled from image 308. A sampling kernel is applied to each spatial location to generate a pixel value for a corresponding spatial location in normalized image 310.

The operation of normalization model 202 in converting image 308 into normalized image 310 may be represented by the following:

$$θ = S ( 𝒥 ) \qquad ( 1 )$$

$${𝒥}^{′} = 𝒲 ( 𝒥 ; θ ) \qquad ( 2 )$$

In the above equations, [symbol] denotes normalization model 202, and [symbol] refers to a resampling operator that, given a transformation corresponding to θ, resamples the original image 308 [symbol] into normalized image 310 [symbol] ′. The number and/or types of parameters in θ may be varied to reflect the class of the 2D transformation predicted by normalization model 202. For example, a similarity transformation may be represented by four scalars that include an isotropic scale, a rotation in the image plane, and a 2D translation. In another example, an affine transformation may be represented using six scalars to model anisotropic scaling, shearing, and/or other types of mappings. In general, any class of 2D transformation may be predicted by normalization model 202.

Because normalized image 310 [symbol] ′ is used as input into landmark prediction model 206, the resulting 2D landmarks 324 lₖ′ lie in the screen space of J′ and not J. On the other hand, ground truth landmarks 232 are defined with respect to the original image 308 J. Consequently, the inverse spatial transformation corresponding to θ-1 can be used to convert lₖ′ into 2D landmarks 326 lₖ that lie in the screen space of J:

$${l}_{k} = 𝒯 ( {l}_{k}^{′} ; {θ}^{- 1} ) \qquad ( 3 )$$

In the above equation, [symbol] denotes applying the 2D transformation corresponding to θ⁻¹ on 2D landmarks 324 lₖ′. When image 308 is used to train machine learning models 200, 2D landmarks 324 and 326 may be included in training 2D landmarks 210. When image 308 is not used to train machine learning models 200, 2D landmarks 324 and/or 326 may correspond to 2D positions 244.

In some embodiments, normalization model 202 is trained in an end-to-end fashion along with landmark prediction model 206. Because the output of normalization model 202 is unsupervised, normalization model 202 may learn a transformation that minimizes losses 212 computed between 2D landmarks 326 and the corresponding ground truth landmarks 232.

Input into deformation model 204 includes individual query points 332 pₖ on canonical shape 236 C. When image 308 is used to train machine learning models 200, query points 332 may be included in ground truth query points 234. When image 308 is not used to train machine learning models 200, query points 332 may correspond to points 228.

Input into deformation model 204 also includes a code 328 Dⱼ∈ [symbol] ^{N} that identifies an annotation style associated with query points 332. When image 308 is used to train machine learning models 200, code 328 may identify one of annotation styles 238. When image 308 is not used to train machine learning models 200, code 328 may identify annotation style 252.

In one or more embodiments, deformation model 204 [symbol] includes a multi-layer perceptron (MLP) and/or another type of machine learning model that predicts displacements 312 dₖ of query points 332 based on code 328. Displacements 312 dₖ are added to the corresponding query points 332 pₖ to produce canonical points 314 pₖ′. When query points 332 are used to train machine learning models 200, displacements 312 may be included in training displacements 218 associated with a given set of ground truth query points 234, and the corresponding points 314 may be included in training points 248 associated with the same ground truth query points 234. Values of these training points 248 may be learned during training to represent all annotation styles in a fair manner. When query points 332 are not used to train machine learning models 200, points 314 may be included in a set of points 228 that are updated with displacements 254.

To ensure that query points 332 corresponding to different annotation styles 238 remain on the manifold of canonical shape 236 [symbol] , query points 332 are defined using coordinates in the parametric UV space of canonical shape 236, and deformation model 204 [symbol] generates 2D displacements in the same UV space. Each displaced UV coordinate is used to sample a position map of canonical shape 236 to generate a corresponding 3D query point pₖ′. Deformation model 204 may thus be used to deform query points 332 from different training datasets to corresponding positions on canonical shape 236 in a way that corrects for inconsistent query point annotations for the same semantic landmark across datasets.

Like normalization model 202, deformation model 204 may trained in an end-to-end fashion along with landmark prediction model 206. During training of deformation model 204, each code 328 Dⱼ may be optimized. For example, code 328 may be set to a 2D vector to train machine learning models 200 using two datasets with two different annotation styles. During training of machine learning models 200, two different codes D₀ and D₁ may be optimized.

Within landmark prediction model 206, a feature extractor 302 denoted by [symbol] generates a set of parameters 316 γᵢ and a set of features 318 fᵢ from an inputted normalized image 310. For example, feature extractor 302 may include a convolutional encoder, a deep neural network (DNN), and/or another type of machine learning model that converts a given normalized image 310 into features 318 in the form of a d-dimensional feature descriptor.

Feature extractor 302 also predicts, from normalized image 310, parameters 316 γᵢ that includes a head pose (R, T) and/or camera intrinsics (f_{d}):

$${f}_{i} , {γ}_{i} = F ( {𝒥}^{′} ) \qquad ( 4 )$$

$${γ}_{i} = [ R , T , {f}_{d} ] \qquad ( 5 )$$

More specifically, the head pose may be parameterized as a nine-dimensional (9D) vector that includes a six-dimensional (6D) rotation vector R and a 3D translation T. The camera intrinsics f_{d} may include a focal length in millimeters (mm) under an ideal pinhole assumption. To bias the training towards plausible focal lengths, f_{d} may be a focal length displacement f_{d} that is added to a predefined focal length f_{fixed} (e.g., 60 mm).

Within landmark prediction model 206, a position encoder 304 denoted by [symbol] converts points 314 pₖ′ into corresponding position encodings 320 qₖ′:

$${q}_{k} = Q ( {p}_{k}^{′} ) \qquad ( 6 )$$

For example, position encoder 304 may include an MLP and/or another type of machine learning model that generates vector-based position encodings 320 qₖ∈ [symbol] ^{B} from 3D positions pₖ′ corresponding to points 314.

Landmark prediction model 206 also includes a prediction network 306 denoted by [symbol] that uses features 318 from feature extractor 302 and position encodings 320 from position encoder 304 to generate 3D landmarks 322 (lₖ^{3d}, cₖ):

$$( {l}_{k}^{3 d} , {c}_{k} ) = 𝒫 ( {f}_{i} , {q}_{k} ) \qquad ( 7 )$$

$${L}_{k}^{3 d} = {l}_{k}^{3 d} + {m}_{k}^{3 d} \qquad ( 8 )$$

More specifically, lₖ^{3d} represents a given 3D landmark in the canonical space associated with canonical shape 236, and cₖ denotes confidence 246 in the landmark. Additionally, lₖ^{3d} is a 3D offset that is added to the corresponding point mₖ^{3d} on canonical shape 236 (or another face shape) to produce a canonical 3D position Lₖ^{3d} of the landmark.

When image 308 is used to train machine learning models 200, 3D landmarks 322 may be included in training 3D landmarks 220. When image 308 is not used to train machine learning models 200, 3D landmarks 322 may correspond to 3D positions 242.

Canonical 3D positions Lₖ^{3d} are transformed using the head pose (R, T) predicted by feature extractor 302 [symbol] to produce pose-specific 3D positions L̅ₖ^{3d}. L̅ₖ^{3d} is then projected through a canonical camera with a focal length of f_{fixed}+f_{d} to generate a set of normalized 2D landmarks 324 lₖ′ in the screen space of normalized image 310:

$${\overline{L}}_{k}^{3 d} = 𝒯 ( {L}_{k}^{3 d} ; R , T ) \qquad ( 9 )$$

$${l}_{k}^{′} = ψ ( {\overline{L}}_{k}^{3 d} ; {f}_{fixed} + {f}_{d} ) \qquad ( 10 )$$

These normalized landmarks lₖ′ are restored to the screen space of image 308 [symbol] using the inverse transformation θ⁻¹, resulting in the final 2D landmarks 326 lₖ. The confidence values cₖ of the 3D landmarks Lₖ^{3d} may also be transferred over to the 2D landmarks 326 lₖ for training with a Gaussian NLL loss (and/or another type of loss). Consequently, machine learning models 200 may be used to infer 3D landmarks 322 after being trained using 2D ground truth landmarks 232.

Returning to the discussion of FIG. 2, after training of normalization model 202, deformation model 204, and/or landmark prediction model 206 is complete, execution engine 124 executes the trained normalization model 202, deformation model 204, and/or landmark prediction model 206 to detect additional landmarks 240 on a new image 222. More specifically, execution engine 124 uses normalization model 202 to generated transformation parameters 224 associated with image 222. Execution engine 124 also uses transformation parameters 224 to convert image 222 into a corresponding normalized image 226.

Execution engine 124 obtains a set of points 228 that specify positions on canonical shape 236 for which landmarks 240 are to be generated. If landmarks 240 are to be generated according to a certain annotation style 252, execution engine 124 uses deformation model 204 to generate displacements 254 that are applied to points 228 based on a code associated with that annotation style 252. If landmarks 240 are to be generated in a manner that is independent of any annotation styles 238 associated with training data 214, generation of displacements 254 is omitted.

Execution engine 124 inputs points 228 (with or without displacements 254) and normalized image 226 into landmark prediction model 206. Execution engine 124 executes landmark prediction model 206 to generate 3D positions 242 as offsets from the corresponding points 228 in canonical shape 236. Execution engine 124 uses additional parameters predicted by the feature extractor in landmark prediction model 206 to project 3D positions 242 onto 2D positions 242 in a 2D space associated with normalized image 226. Execution engine 124 then uses transformation parameters 224 to compute an inverse transformation that is used to convert 2D positions 242 in the 2D space associated with normalized image 226 into 2D positions 242 in the 2D space associated with image 222.

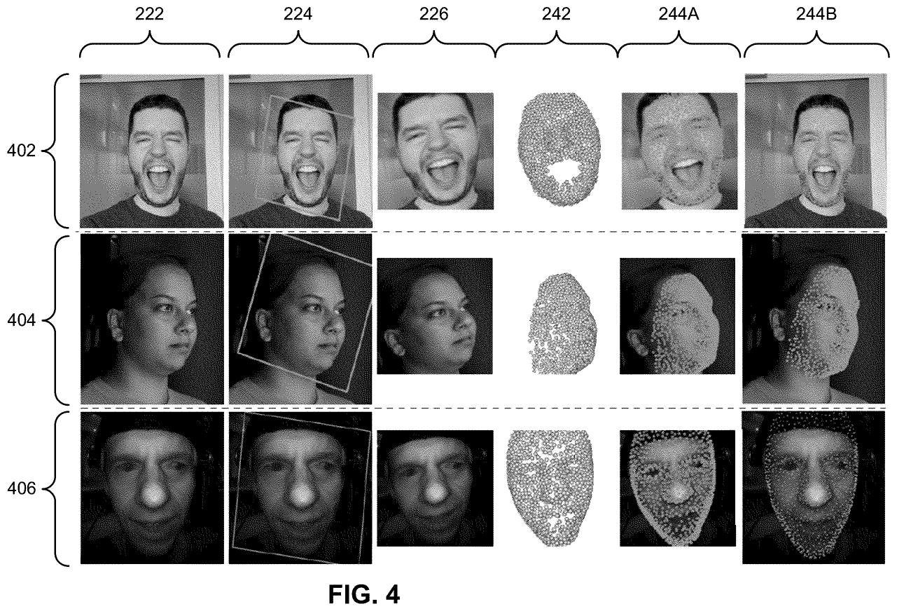

FIG. 4 illustrates different sets of data 402, 404, and 406 associated with machine learning models 200 of FIG. 2, according to various embodiments. Each set of data 402, 404, and 406 include an input image 222, a transformation represented by a set of transformation parameters 224, a corresponding normalized image 226, 3D positions 242 for a set of landmarks 240, 2D positions 244A for the same landmarks 240 in a 2D space associated with normalized image 226, and 2D positions 244B for the same landmarks 240 in a 2D space associated with image 222.

More specifically, FIG. 4 illustrates data 402, 404, and 406 that is used to perform landmark detection under different scenarios. Data 402 includes a given image 222 that is captured “in-the-wild” by a mobile device, data 404 includes a given image 222 that is captured in a studio, and data 406 includes a given image 222 that is captured using a helmet-mounted camera. Each set of transformation parameters 224 is applied to the corresponding image 222 to generate a given normalized image 226 that crops and resizes the face in that image 222. 3D positions 242 for landmarks 240 are generated from normalized image 226 and projected onto the same normalized image 226 to obtain 2D positions 244A. 2D positions 244A are then converted into 2D positions 244B via a transformation that is the inverse of the transformation used to convert image 222 into normalized image 226. As shown in FIG. 4, machine learning models 200 are capable of generating normalized images, 3D landmarks, and 2D landmarks for faces captured by different cameras, from different perspectives, under different lighting conditions, in different poses, and/or in different facial expressions.

Returning to the discussion of FIG. 2, in some embodiments, execution engine 124 uses 3D positions 242, 2D positions 244, and/or other output associated with machine learning models 200 to perform various downstream tasks associated with facial landmark detection. More specifically, execution engine 124 may use 3D positions 242 to perform face reconstruction. For example, execution engine 124 may densely query every point 228 on canonical shape 236 and use the resulting 3D positions 242 to form a full face mesh that matches normalized image 226.

Execution engine 124 may also, or instead, generate textures associated with a face depicted in one or more images. For example, a set of 3D positions 242 may be predicted for each skin point on canonical shape 236 and each view of a face. The pixel colors from normalized image 226 for a given view may then be reprojected onto a posed mesh that is created using Lₖ^{3d} and shares the same triangles as canonical shape 236. The reprojected pixel colors for each view may then be unwrapped into a texture using the UV parameterization of canonical shape 236. View-specific textures may then be averaged across the views to generate a single combined texture.

Execution engine 124 may also, or instead, estimate the visibility of 2D landmarks 240 using the corresponding 3D positions 242. For example, execution engine 124 may generate a 3D mesh using 3D positions 242. Execution engine 124 may determine if the landmark associated with each 3D position is visible based on the angle between the normal vector of the face at the landmark and the direction of the camera, the depth of each 3D position relative to the camera, and/or other techniques.

Execution engine 124 may also, or instead, perform facial segmentation using 2D positions 244 and/or 3D positions 242 of landmarks 240. For example, execution engine 124 may segment image 222 and/or normalized image 226 into regions representing different parts of the face (e.g., nose, lips, eyes, cheeks, forehead, patches of skin, arbitrarily defined regions, etc.). Each region may be associated with a subset of points 228 on canonical shape 236. These points may be converted into 2D positions 244 on normalized image 226 and/or image 222 and/or 3D positions 242 associated with canonical shape 236. The predicted 2D positions 244 may identify a set of pixels within a corresponding image that correspond to the region, and the predicted 3D positions 242 may identify a portion of a face mesh that corresponds to the region.

Execution engine 124 may also, or instead, perform landmark tracking. For example, a user may define a set of points (e.g., moles, blemishes, facial features, pores, etc.) to be tracked on a face depicted within an image. Execution engine 124 may use machine learning models 200 to optimize for corresponding points 228 on canonical shape 236. Execution engine 124 may then use the same points 228 to generate 2D and/or 3D landmarks 240 corresponding to the specified points 228 over a series of video frames and/or one or more additional images of the same face. The generated landmarks 240 may then be used to touch-up, “paint,” and/or otherwise edit the corresponding locations within the video frames, image(s), and/or meshes.

While the operation of training engine 122 and execution engine 124 has been described with respect to a set of machine learning models 200 that include normalization model 202, deformation model 204, and landmark prediction model 206, it will be appreciated that normalization model 202, deformation model 204, and/or landmark prediction model 206 may be combined in other ways and/or used independently of one another. For example, normalization model 202 may be used to generate normalized images for a variety of 2D and/or 3D landmark detectors. In another example, normalization model 202 and deformation model 204 may be used to perform preprocessing of input into the same landmark detector, or each of normalization model 202 and deformation model 204 may be used individually with a given landmark detector. In a third example, landmark prediction model 206 may be used to generate 3D landmarks and/or 2D landmarks with or without preprocessing performed by normalization model 202 and/or deformation model 204.

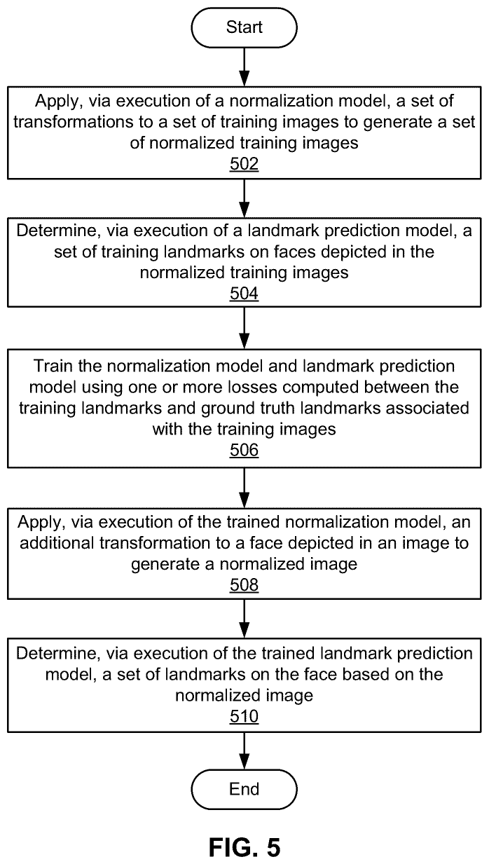

FIG. 5 is a flow diagram of method steps for performing joint image normalization and landmark detection, according to various embodiments. Although the method steps are described in conjunction with FIGS. 1-2, persons skilled in the art will understand that any system configured to perform the method steps, in any order, falls within the scope of the present disclosure.

As shown, in step 502, training engine 122 applies, via execution of a normalization model, a set of transformations to a set of training images to generate a set of normalized training images. For example, training engine 122 may input each training image into the normalization model and use the normalization model to generate a set of transformation parameters associated with the training image. Training engine 122 may use the transformation parameters to generate a sampling grid that specifies a set of spatial locations to be sampled from the training image. Training engine 122 may then apply a sampling kernel to each spatial location in the sampling grid to generate a pixel value for a corresponding spatial location in a normalized training image.

In step 504, training engine 122 determines, via execution of a landmark prediction model, a set of training landmarks on faces depicted in the normalized training images. For example, training engine 122 may input each normalized training image into the landmark prediction model. Training engine 122 may also use the landmark prediction model to convert the input into one or more sets of 2D and/or 3D training landmarks.

In step 506, training engine 122 trains the normalization model and landmark prediction model using one or more losses computed between the training landmarks and ground truth landmarks associated with the training images. For example, training engine 122 may compute the loss(es) as a Gaussian negative log likelihood loss, mean squared error, and/or another measure of difference between the training landmarks and ground truth landmarks. Training engine 122 may additionally use a training technique (e.g., gradient descent and backpropagation) to iteratively update weights of the normalization model and landmark prediction model in a way that reduces the loss(es).

In step 508, execution engine 124 applies, via execution of the trained normalization model, an additional transformation to a face depicted in an image to generate a normalized image. For example, execution engine 124 may use the trained normalization model to generate an additional set of transformation parameters associated with the image. Execution engine 124 may also apply the corresponding transformation to the image to produce the normalized image.

In step 510, execution engine 124 determines, via execution of the trained landmark prediction model, a set of landmarks on the face based on the normalized image. For example, execution engine 124 may input the normalized image into the trained landmark prediction model. Execution engine 124 may obtain, as corresponding output of the trained landmark prediction model, 2D landmarks in the image and/or normalized image and/or 3D landmarks associated with a canonical shape.

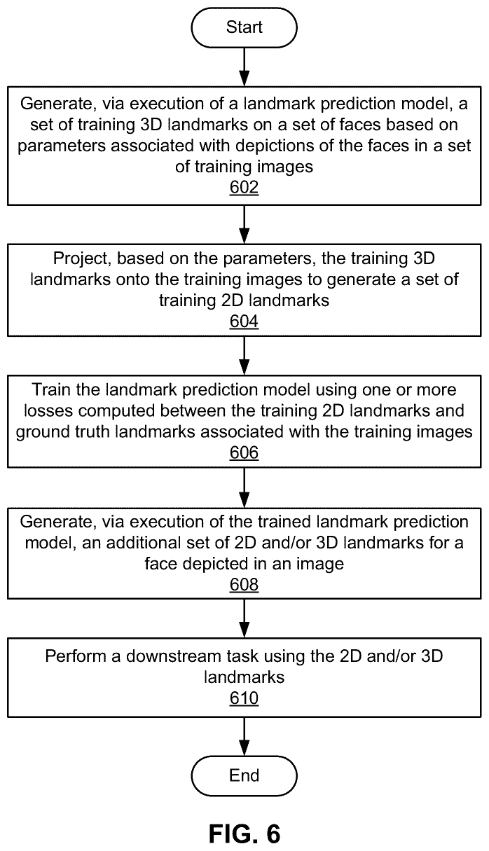

FIG. 6 is a flow diagram of method steps for performing flexible three-dimensional (3D) landmark detection, according to various embodiments. Although the method steps are described in conjunction with FIGS. 1-2, persons skilled in the art will understand that any system configured to perform the method steps, in any order, falls within the scope of the present disclosure.

As shown, in step 602, training engine 122 generates, via execution of a landmark prediction model, a set of training 3D landmarks on a set of faces based on parameters associated with depictions of the faces in a set of training images. For example, training engine 122 may input, into the landmark prediction model, normalized training images that corresponds to cropping and resizing of faces in the training images. Training engine 122 may use a feature extractor in the landmark prediction model to generate a set of features representing each normalized training image and a set of parameters associated with a depiction of the face in the normalized training image. The parameters may include a head pose and/or a camera parameter. Training engine 122 may input the parameters (and optional position-encoded points on a canonical shape) into a prediction network in the landmark prediction model and use the prediction network to generate a set of 3D training landmarks for the face in the normalized training image.

In step 604, training engine 122 projects, based on the parameters, the training 3D landmarks onto the training images to generate a set of training 2D landmarks. Continuing with the above example, training engine 122 may use the head pose and/or camera parameters to project the training 3D landmarks onto the training normalized images, thereby generating the training 2D landmarks in the screen spaces of the training normalized images. Training engine 122 may also use an inverted transform associated with generation of each training normalized image to convert the training 2D landmarks in the screen spaces of the training normalized images into corresponding training 2D landmarks in the screen spaces of the corresponding training images.

In step 606, training engine 122 trains the landmark prediction model using one or more losses computed between the training 2D landmarks and ground truth landmarks associated with the training images. For example, training engine 122 may compute the loss(es) as measures of error between the training 2D landmarks and ground truth landmarks. Training engine 122 may then update the parameters of the landmark prediction model in a way that reduces the loss(es).

In step 608, execution engine 124 uses the trained landmark prediction model to generate an additional set of 2D and/or 3D landmarks for a face depicted in an image. For example, execution engine 124 may input a normalized version of the image into the trained landmark prediction model. Execution engine 124 may use the trained landmark prediction model to convert the input into 3D landmarks in a canonical space and/or 2D landmarks in a screen space associated with the image and/or the normalized version of the image.

In step 610, execution engine 124 performs a downstream task using the 2D and/or 3D landmarks. For example, execution engine 124 may use the generated landmarks to perform face reconstruction, texture generation, visibility estimation, facial segmentation, landmark tracking, and/or other tasks involving 2D and/or 3D landmarks.

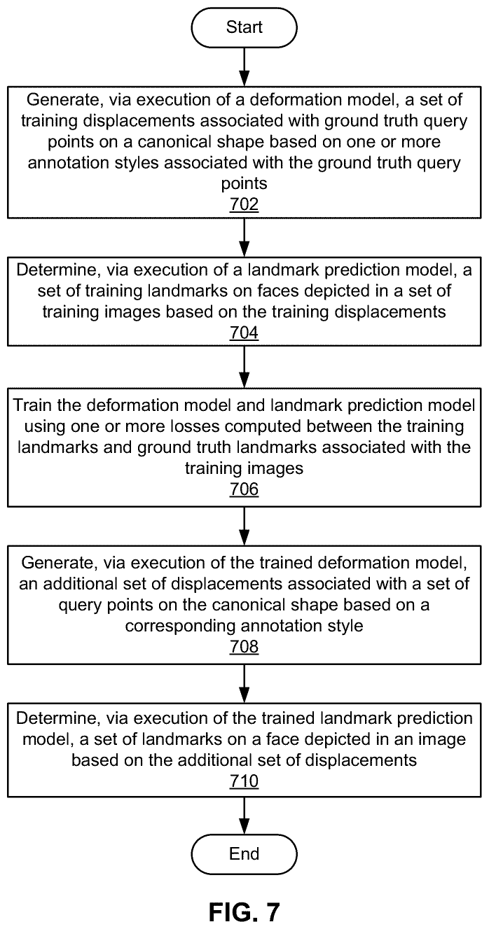

FIG. 7 is a flow diagram of method steps for performing query deformation for landmark annotation correction, according to various embodiments. Although the method steps are described in conjunction with FIGS. 1-2, persons skilled in the art will understand that any system configured to perform the method steps, in any order, falls within the scope of the present disclosure.

As shown, in step 702, training engine 122 generates, via execution of a deformation model, a set of training displacements associated with ground truth query points on a canonical shape based on one or more annotation styles associated with the ground truth query points. For example, training engine 122 may input a code representing an annotation style and a ground truth query point into the deformation model. Training engine 122 may use the deformation model to convert the input into a displacement of the ground truth query point on a surface of the canonical shape.

In step 704, training engine 122 determines, via execution of a landmark prediction model, a set of training landmarks on faces depicted in a set of training images based on the training displacements. For example, training engine 122 may apply (e.g., add) the training displacements to the corresponding ground truth query points to generate training points that are associated with individual annotation styles. Training engine 122 may input the training points and normalized versions of training images associated with the same annotation styles into the landmark prediction model. Training engine 122 may use the landmark prediction model to convert the input into training 3D landmarks and/or training 2D landmarks associated with the ground truth query points.

In step 706, training engine 122 trains the deformation model and landmark prediction model based on one or more losses computed between the training landmarks and ground truth landmarks associated with the training images. Continuing with the above example, training engine 122 may compute the loss(es) 212 as measures of error between the training landmarks and corresponding ground truth landmarks. Training engine 122 may also use the loss(es) to update parameters of the deformation model and landmark prediction model and/or codes representing the annotation styles.

In step 708, execution engine 124 generates, via execution of the trained deformation model, an additional set of displacements associated with a set of query points on the canonical shape based on a corresponding annotation style. For example, execution engine 124 may use the trained deformation model to convert an optimized code for the annotation style and the query points into corresponding displacements.

In step 710, execution engine 124 determines, via execution of the trained landmark prediction model, a set of landmarks on a face depicted in an image based on the additional set of displacements. For example, execution engine 124 may apply the additional set of displacements to the query points. Execution engine 124 may also use the trained landmark prediction model to convert the displaced query points and the image into 3D and/or 2D landmarks. To generate landmarks that are agnostic to a particular annotation style after the deformation model and landmark prediction model are trained, step 708 may be omitted, and step 710 may be performed using the original set of query points instead of displaced query points.

In sum, the disclosed techniques use a set of machine learning models to perform and/or improve various tasks related to facial landmark detection. One task involves training a normalization model that predicts parameters used to normalize an image in an end-to-end fashion with a landmark detection model that generates 2D and/or 3D landmarks from the normalized image. After training is complete, the normalization model learns to normalize face images in a manner that is optimized for the downstream facial landmark detection task performed by the landmark detection model. Another task involves predicting a pose, head shape, camera parameters, and/or other attributes associated with the landmarks in a canonical three-dimensional (3D) space, and using the predicted attributes to predict 3D landmarks in the same canonical space while using two-dimensional (2D) landmarks as supervision. A third task involves displacing query points associated with different annotation styles in training data for the facial landmark detection task to correct for semantic inconsistencies in query point annotations across different datasets.

One technical advantage of the disclosed techniques relative to the prior art is the ability to perform an image normalization task in a manner that is optimized for a subsequent facial landmark detection task. Accordingly, the disclosed techniques may improve the accuracy of the detected landmarks over conventional techniques that perform face normalization as a preprocessing step that is decoupled from the landmark detection task. Another technical advantage of the disclosed techniques is the ability to predict the landmarks as 3D positions in a canonical space. These 3D positions may then be used to perform 3D facial reconstruction, texture completion, visibility estimation, and/or other tasks, thereby reducing latency and resource overhead over prior techniques that generate 2D landmarks and perform additional processing related to the 2D landmarks during downstream tasks. These predicted attributes may additionally result in more stable 2D landmarks than conventional approaches that perform landmark detection only in 2D space. An additional technical advantage of the disclosed techniques is the ability to correct semantic inconsistencies across datasets used to train landmark detectors. Consequently, the disclosed techniques may improve training convergence and/or landmark prediction performance over conventional techniques that do not account for discrepancies in annotation styles associated with different landmark detection datasets. These technical advantages provide one or more technological improvements over prior art approaches.
1. In some embodiments, a computer-implemented method for performing landmark detection comprises applying, via execution of a first machine learning model, a first transformation to a first image depicting a first face to generate a second image; determining, via execution of a second machine learning model, a first set of landmarks on the first face based on the second image; and training the first machine learning model based on one or more losses associated with the first set of landmarks to generate a first trained machine learning model.
2. The computer-implemented method of clause 1, further comprising training the second machine learning model based on the one or more losses to generate a second trained machine learning model.
3. The computer-implemented method of any of clauses 1-2, further comprising applying, via execution the first trained machine learning model, a second transformation to a second face depicted in a third image to generate a fourth image; and determining, via execution of the second trained machine learning model, a second set of landmarks on the second face based on the fourth image.
4. The computer-implemented method of any of clauses 1-3, wherein determining the second set of landmarks comprises inputting, into the second trained machine learning model, (i) a set of points on a canonical shape and (ii) the fourth image; and generating, by the second trained machine learning model, the second set of landmarks as a set of positions of the set of points within the fourth image.
5. The computer-implemented method of any of clauses 1-4, wherein applying the first transformation to the first image comprises generating, via execution of the first machine learning model, a set of parameters corresponding to the first transformation based on the first image; generating a sampling grid associated with the first image based on the set of parameters, wherein the sampling grid specifies a set of spatial locations to be sampled from the first image; and applying a sampling kernel to each spatial location included in the set of spatial locations to generate a pixel value for a corresponding spatial location in the second image.
6. The computer-implemented method of any of clauses 1-5, wherein determining the first set of landmarks comprises converting, via execution of a feature detector included in the second machine learning model, the second image into a set of features; and generating, via execution of a prediction network included in the second machine learning model, the first set of landmarks as a set of positions within the second image, wherein the set of positions corresponds to a set of key points on the first face.
7. The computer-implemented method of any of clauses 1-6, wherein determining the first set of landmarks further comprises generating a set of confidence values associated with the set of positions.
8. The computer-implemented method of any of clauses 1-7, wherein training the first machine learning model comprises determining, within the second image, a first set of positions that corresponds to the first set of landmarks; applying a second transformation that is an inverse of the first transformation to the first set of positions to generate a second set of positions in the first image; and computing the one or more losses based on the second set of positions and a set of ground truth positions associated with the first set of landmarks.
9. The computer-implemented method of any of clauses 1-8, wherein the first machine learning model comprises a spatial transformer neural network.
10. The computer-implemented method of any of clauses 1-9, wherein the first transformation comprises an affine transformation.
11. In some embodiments, one or more non-transitory computer readable media stores instructions that, when executed by one or more processors, cause the one or more processors to perform the steps of applying, via execution of a first machine learning model, a first transformation to a first image depicting a first face to generate a second image; determining, via execution of a second machine learning model, a first set of landmarks on the first face based on the second image; and training the first machine learning model based on one or more losses associated with the first set of landmarks to generate a first trained machine learning model.
12. The one or more non-transitory computer readable media of clause 11, wherein the instructions further cause the one or more processors to perform the step of training the second machine learning model based on the one or more losses to generate a second trained machine learning model.
13. The one or more non-transitory computer readable media of any of clauses 11-12, wherein the instructions further cause the one or more processors to perform the steps of applying, via execution the first trained machine learning model, a second transformation to a second face depicted in a third image to generate a fourth image; inputting, into the second trained machine learning model, (i) a set of points on a canonical shape and (ii) the fourth image; and generating, by the second trained machine learning model, a second set of landmarks on the second face as a set of positions of the set of points within the fourth image.
14. The one or more non-transitory computer readable media of any of clauses 11-13, wherein applying the first transformation to the first image comprises generating, via execution of the first machine learning model, a set of parameters corresponding to the first transformation based on the first image; generating a sampling grid associated with the first image based on the set of parameters, wherein the sampling grid specifies a set of spatial locations to be sampled from the first image; and applying a sampling kernel to each spatial location included in the set of spatial locations to generate a pixel value for a corresponding spatial location in the second image.
15. The one or more non-transitory computer readable media of any of clauses 11-14, wherein determining the first set of landmarks comprises converting the second image into a set of features and a set of parameters; converting a set of points on a canonical shape into a set of position encodings; and generating, based on the set of features and the set of position encodings, a set of three-dimensional (3D) positions that is (i) included in the first set of landmarks and (ii) in a canonical space associated with the canonical shape.
16. The one or more non-transitory computer readable media of any of clauses 11-15, wherein determining the first set of landmarks further comprises applying, based on the set of parameters, one or more additional transformations to the set of 3D positions to generate a first set of two-dimensional (2D) positions that is (i) included in the first set of landmarks and (ii) in a first 2D space associated with the second image; and applying a second transformation that is an inverse of the first transformation to the first set of 2D positions to generate a second set of 2D positions that is (i) included in the first set of landmarks and (ii) in a second 2D space associated with the first image.
17. The one or more non-transitory computer readable media of any of clauses 11-16, wherein determining the first set of landmarks further comprises determining the set of points based on a set of displacements of a set of query points associated with the first set of landmarks.
18. The one or more non-transitory computer readable media of any of clauses 11-17, wherein the first set of landmarks comprises (i) a set of positions within the second image and (ii) a set of confidence values associated with the set of positions.
19. The one or more non-transitory computer readable media of any of clauses 11-18, wherein the one or more losses comprise a Gaussian negative likelihood loss.
20. In some embodiments, a computer system comprises one or more memories that store instructions; and one or more processors that are coupled to the one or more memories and, when executing the instructions, are configured to perform the steps of determining a first machine learning model and a second machine learning model, wherein the first machine learning model and the second machine learning model are trained based on one or more losses associated with a first set of landmarks generated by the second machine learning model from input that includes a transformed image generated via execution of the first machine learning model; applying, via execution of the first machine learning model, a transformation to a first image depicting a first face to generate a second image; and determining, via execution of the second machine learning model, a second set of landmarks on the first face based on the second image.
21. In some embodiments, a computer-implemented method for performing landmark detection comprises determining a first set of parameters associated with a depiction of a first face in a first image; generating, via execution of a first machine learning model, a first set of three-dimensional (3D) landmarks on the first face based on the first set of parameters; projecting, based on the first set of parameters, the first set of 3D landmarks onto the first image to generate a first set of two-dimensional (2D) landmarks; and training the first machine learning model based on one or more losses associated with the first set of 2D landmarks to generate a first trained machine learning model.
22. The computer-implemented method of clause 21, further comprising training, based on the one or more losses, a second machine learning model that generates the first set of parameters to generate a second trained machine learning model.
23. The computer-implemented method of any of clauses 21-22, further comprising determining a second set of parameters associated with a depiction of a second face in a second image; and generating, via execution of the first trained machine learning model, a second set of 3D landmarks on the second face based on the second set of parameters.
24. The computer-implemented method of any of clauses 21-23, further comprising reconstructing a 3D shape of the second face based on the second set of 3D landmarks.
25. The computer-implemented method of any of clauses 21-24, further comprising determining, based on the second set of 3D landmarks and the second set of parameters, a set of visibilities of the second set of 3D landmarks within the second image.
26. The computer-implemented method of any of clauses 21-25, further comprising generating a texture for the second face based on a projection of a set of pixel values from the second image onto a mesh that is generated based on the second set of 3D landmarks.
27. The computer-implemented method of any of clauses 21-26, further comprising projecting, based on the second set of parameters, the second set of 3D landmarks onto the second image to generate a second set of 2D landmarks.
28. The computer-implemented method of any of clauses 21-27, wherein generating the first set of 3D landmarks comprises converting a set of points on a canonical shape into a set of position encodings; and generating, via execution of the first machine learning model, the first set of 3D landmarks based on (i) a set of features associated with the first image, (ii) the first set of parameters, and (iii) the set of position encodings.
29. The computer-implemented method of any of clauses 21-28, wherein projecting the first set of 3D landmarks onto the first image comprises transforming the first set of 3D landmarks into a second set of 3D landmarks based on a head pose included in the first set of parameters; and projecting the second set of 3D landmarks based on a focal length included in the first set of parameters to generate the first set of 2D landmarks.
30. The computer-implemented method of any of clauses 21-29, wherein the first set of 3D landmarks comprises a set of offsets from a canonical shape.
31. In some embodiments, one or more non-transitory computer-readable media store instructions that, when executed by one or more processors, cause the one or more processors to perform the steps of determining a first set of parameters associated with a depiction of a first face in a first image; generating, via execution of a first machine learning model, a first set of three-dimensional (3D) landmarks on the first face based on the first set of parameters; projecting, based on the first set of parameters, the first set of 3D landmarks onto the first image to generate a first set of two-dimensional (2D) landmarks; and training the first machine learning model based on one or more losses associated with the first set of 2D landmarks to generate a first trained machine learning model.
32. The one or more non-transitory computer-readable media of clause 31, wherein the instructions further cause the one or more processors to perform the steps of applying, via execution of a second machine learning model, a transformation to a second image to generate the first image; and training the second machine learning model based on the one or more losses.
33. The one or more non-transitory computer-readable media of any of clauses 31-32, wherein the instructions further cause the one or more processors to perform the steps of generating, via execution of a second machine learning model, a set of points on a canonical shape, wherein the set of points corresponds to displacements of a set of query points associated with the first set of 3D landmarks; further generating the first set of 3D landmarks based on the set of points; and training the second machine learning model based on the one or more losses.
34. The one or more non-transitory computer-readable media of any of clauses 31-33, wherein the instructions further cause the one or more processors to perform the steps of determining a second set of parameters associated with a depiction of a second face in a second image; and generating, via execution of the first trained machine learning model, a second set of 3D landmarks on the second face based on the second set of parameters.
35. The one or more non-transitory computer-readable media of any of clauses 31-34, wherein the instructions further cause the one or more processors to perform the step of reconstructing a 3D shape of the second face based on the second set of 3D landmarks.
36. The one or more non-transitory computer-readable media of any of clauses 31-35, wherein the instructions further cause the one or more processors to perform the step of generating a texture for the second face based on a projection of a set of pixel values from the second image onto the 3D shape.
37. The one or more non-transitory computer-readable media of any of clauses 31-36, wherein the instructions further cause the one or more processors to perform the step of generating a texture for the second face based on a projection of a set of pixel values from the second image onto a mesh that is generated based on the second set of 3D landmarks.
38. The one or more non-transitory computer-readable media of any of clauses 31-37, wherein the one or more losses comprise a Gaussian negative likelihood loss.
39. The one or more non-transitory computer-readable media of any of clauses 31-38, wherein the first set of parameters comprises at least one of a camera parameter or a pose of a head associated with the first face.
40. In some embodiments, a system comprises one or more memories that store instructions, and one or more processors that are coupled to the one or more memories and, when executing the instructions, are configured to perform the steps of determining a first machine learning model, wherein the first machine learning model is trained based on one or more losses associated with a projection of a first set of three-dimensional (3D) landmarks generated by the first machine learning model onto a two-dimensional (2D) space; determining a set of parameters associated with a depiction of a face in an image; generating, via execution of the first machine learning model, a second set of three-dimensional (3D) landmarks on the face based on the set of parameters; and reconstructing a 3D shape of the face based on the second set of 3D landmarks.
41. In some embodiments, a computer-implemented method for performing landmark detection comprises generating, via execution of a first machine learning model, a first set of displacements associated with a first set of query points on a canonical shape based on a first annotation style associated with the first set of query points; determining, via execution of a second machine learning model, a first set of landmarks on a first face depicted in a first image based on the first set of displacements; and training the first machine learning model based on one or more losses associated with the first set of landmarks to generate a first trained machine learning model.
42. The computer-implemented method of clause 41, further comprising generating, via execution of the first machine learning model, a second set of displacements associated with a second set of query points on the canonical shape based on a second annotation style associated with the second set of query points; determining, via execution of the second machine learning model, a second set of landmarks on a second face depicted in a second image based on the second set of displacements; and updating the one or more losses based on the second set of landmarks.
43. The computer-implemented method of any of clauses 41-42, further comprising training the second machine learning model based on the one or more losses to generate a second trained machine learning model.
44. The computer-implemented method of any of clauses 41-43, further comprising generating, via execution of the first trained machine learning model, a second set of displacements associated with a second set of query points on the canonical shape based on the first annotation style; and determining, via execution of the second trained machine learning model, a second set of landmarks on a second face depicted in a second image based on the second set of displacements.
45. The computer-implemented method of any of clauses 41-44, wherein determining the second set of landmarks comprises applying the second set of displacements to the second set of query points to generate a set of points on the canonical shape; inputting, into the second trained machine learning model, (i) the set of points and (ii) the second image; and generating, by the second trained machine learning model, the second set of landmarks as a set of positions of the set of points within the second image.
46. The computer-implemented method of any of clauses 41-45, wherein generating the first set of displacements comprises inputting, into the first machine learning model, (i) a code for a dataset associated with the first annotation style and (ii) a query point included in the first set of query points; and generating, by the first machine learning model, a displacement of the query point that is included in the first set of query points.
47. The computer-implemented method of any of clauses 41-46, wherein determining the first set of landmarks comprises converting, via execution of a feature detector included in the second machine learning model, the first image into a set of features; and generating, via execution of a prediction network included in the second machine learning model based on the set of features and the first set of displacements, the first set of landmarks as a set of positions within the first image.
48. The computer-implemented method of any of clauses 41-47, wherein determining the first set of landmarks further comprises generating a set of confidence values associated with the set of positions.
49. The computer-implemented method of any of clauses 41-48, wherein training the first machine learning model comprises updating a code representing the first annotation style based on the one or more losses.
50. The computer-implemented method of any of clauses 41-49, wherein the first machine learning model comprises a multi-layer perceptron.
51. In some embodiments, one or more non-transitory computer-readable media store instructions that, when executed by one or more processors, cause the one or more processors to perform the steps of generating, via execution of a first machine learning model, a first set of displacements associated with a first set of query points on a canonical shape based on a first annotation style associated with the first set of query points; determining, via execution of a second machine learning model, a first set of landmarks on a first face depicted in a first image based on the first set of displacements; and training the first machine learning model based on one or more losses associated with the first set of landmarks to generate a first trained machine learning model.
52. The one or more non-transitory computer-readable media of clause 51, wherein the instructions further cause the one or more processors to perform the steps of generating, via execution of the first machine learning model, a second set of displacements associated with a second set of query points on the canonical shape based on a second annotation style associated with the second set of query points; determining, via execution of the second machine learning model, a second set of landmarks on a second face depicted in a second image based on the second set of displacements; and updating the one or more losses based on the second set of landmarks.
53. The one or more non-transitory computer-readable media of any of clauses 51-52, wherein the instructions further cause the one or more processors to perform the step of training the second machine learning model based on the one or more losses to generate a second trained machine learning model.
54. The one or more non-transitory computer-readable media of any of clauses 51-53, wherein the instructions further cause the one or more processors to perform the steps of generating, via execution of the first trained machine learning model, a second set of displacements associated with a second set of query points on the canonical shape based on the first annotation style; applying the second set of displacements to the second set of query points to generate a set of points on the canonical shape; inputting, into the second trained machine learning model, (i) the set of points and (ii) a second image depicting a second face; and generating, by the second trained machine learning model, a second set of landmarks as a set of positions of the set of points within the second image.
55. The one or more non-transitory computer-readable media of any of clauses 51-54, wherein determining the first set of landmarks comprises converting the first image into a set of features and a set of parameters; converting a set of points corresponding to the first set of displacements applied to the first set of query points into a set of position encodings; and generating, based on the set of features and the set of position encodings, a set of three-dimensional (3D) positions that is (i) included in the first set of landmarks and (ii) in a canonical space associated with the canonical shape.
56. The one or more non-transitory computer-readable media of any of clauses 51-55, wherein determining the first set of landmarks further comprises applying, based on the set of parameters, one or more transformations to the set of 3D positions to generate a first set of two-dimensional (2D) positions that is (i) included in the first set of landmarks and (ii) in a first 2D space associated with the first image.
57. The one or more non-transitory computer-readable media of any of clauses 51-56, wherein the instructions further cause the one or more processors to perform the steps of applying, via execution of a third machine learning model, a transformation to a second image to generate the first image; and training the third machine learning model based on the one or more losses.
58. The one or more non-transitory computer-readable media of any of clauses 51-57, wherein the first set of landmarks comprises (i) a set of positions within the first image and (ii) a set of confidence values associated with the set of positions.
59. The one or more non-transitory computer-readable media of any of clauses 51-58, wherein the one or more losses comprise a Gaussian negative likelihood loss.
60. In some embodiments, a system comprises one or more memories that store instructions, and one or more processors that are coupled to the one or more memories and, when executing the instructions, are configured to perform the steps of generating, via execution of a first machine learning model, a first set of displacements associated with a first set of query points on a canonical shape based on a first annotation style associated with the first set of query points; determining, via execution of a second machine learning model, a first set of landmarks on a first face depicted in a first image based on the first set of displacements; and training the first machine learning model and the second machine learning model based on one or more losses associated with the first set of landmarks.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing landmark detection, the method comprising:
determining a first set of parameters associated with a depiction of a first face in a first image;
generating, via execution of a first machine learning model, a first set of three-dimensional (3D) landmarks on the first face based on the first set of parameters;
projecting, based on the first set of parameters, the first set of 3D landmarks onto the first image to generate a first set of two-dimensional (2D) landmarks; and
training the first machine learning model based on one or more losses associated with the first set of 2D landmarks to generate a first trained machine learning model.

2. The computer-implemented method of claim 1, further comprising training, based on the one or more losses, a second machine learning model that generates the first set of parameters to generate a second trained machine learning model.

3. The computer-implemented method of claim 1, further comprising:
determining a second set of parameters associated with a depiction of a second face in a second image; and
generating, via execution of the first trained machine learning model, a second set of 3D landmarks on the second face based on the second set of parameters.

4. The computer-implemented method of claim 3, further comprising reconstructing a 3D shape of the second face based on the second set of 3D landmarks.

5. The computer-implemented method of claim 3, further comprising determining, based on the second set of 3D landmarks and the second set of parameters, a set of visibilities of the second set of 3D landmarks within the second image.

6. The computer-implemented method of claim 3, further comprising generating a texture for the second face based on a projection of a set of pixel values from the second image onto a mesh that is generated based on the second set of 3D landmarks.

7. The computer-implemented method of claim 3, further comprising projecting, based on the second set of parameters, the second set of 3D landmarks onto the second image to generate a second set of 2D landmarks.

8. The computer-implemented method of claim 1, wherein generating the first set of 3D landmarks comprises:
converting a set of points on a canonical shape into a set of position encodings; and
generating, via execution of the first machine learning model, the first set of 3D landmarks based on (i) a set of features associated with the first image, (ii) the first set of parameters, and (iii) the set of position encodings.

9. The computer-implemented method of claim 1, wherein projecting the first set of 3D landmarks onto the first image comprises:
transforming the first set of 3D landmarks into a second set of 3D landmarks based on a head pose included in the first set of parameters; and
projecting the second set of 3D landmarks based on a focal length included in the first set of parameters to generate the first set of 2D landmarks.

10. The computer-implemented method of claim 1, wherein the first set of 3D landmarks comprises a set of offsets from a canonical shape.

11. One or more non-transitory computer-readable media storing instructions that, when executed by one or more processors, cause the one or more processors to perform the steps of:
determining a first set of parameters associated with a depiction of a first face in a first image;
generating, via execution of a first machine learning model, a first set of three-dimensional (3D) landmarks on the first face based on the first set of parameters;
projecting, based on the first set of parameters, the first set of 3D landmarks onto the first image to generate a first set of two-dimensional (2D) landmarks; and
training the first machine learning model based on one or more losses associated with the first set of 2D landmarks to generate a first trained machine learning model.

12. The one or more non-transitory computer-readable media of claim 11, wherein the instructions further cause the one or more processors to perform the steps of:
applying, via execution of a second machine learning model, a transformation to a second image to generate the first image; and
training the second machine learning model based on the one or more losses.

13. The one or more non-transitory computer-readable media of claim 11, wherein the instructions further cause the one or more processors to perform the steps of:
generating, via execution of a second machine learning model, a set of points on a canonical shape, wherein the set of points corresponds to displacements of a set of query points associated with the first set of 3D landmarks;
further generating the first set of 3D landmarks based on the set of points; and
training the second machine learning model based on the one or more losses.

14. The one or more non-transitory computer-readable media of claim 11, wherein the instructions further cause the one or more processors to perform the steps of:
determining a second set of parameters associated with a depiction of a second face in a second image; and
generating, via execution of the first trained machine learning model, a second set of 3D landmarks on the second face based on the second set of parameters.

15. The one or more non-transitory computer-readable media of claim 14, wherein the instructions further cause the one or more processors to perform the step of reconstructing a 3D shape of the second face based on the second set of 3D landmarks.

16. The one or more non-transitory computer-readable media of claim 15, wherein the instructions further cause the one or more processors to perform the step of generating a texture for the second face based on a projection of a set of pixel values from the second image onto the 3D shape.

17. The one or more non-transitory computer-readable media of claim 14, wherein the instructions further cause the one or more processors to perform the step of generating a texture for the second face based on a projection of a set of pixel values from the second image onto a mesh that is generated based on the second set of 3D landmarks.

18. The one or more non-transitory computer-readable media of claim 11, wherein the one or more losses comprise a Gaussian negative likelihood loss.

19. The one or more non-transitory computer-readable media of claim 11, wherein the first set of parameters comprises at least one of a camera parameter or a pose of a head associated with the first face.

20. A system, comprising:
one or more memories that store instructions, and
one or more processors that are coupled to the one or more memories and, when executing the instructions, are configured to perform the steps of:
determining a first machine learning model, wherein the first machine learning model is trained based on one or more losses associated with a projection of a first set of three-dimensional (3D) landmarks generated by the first machine learning model onto a two-dimensional (2D) space;
determining a set of parameters associated with a depiction of a face in an image;
generating, via execution of the first machine learning model, a second set of three-dimensional (3D) landmarks on the face based on the set of parameters; and
reconstructing a 3D shape of the face based on the second set of 3D landmarks.
